(19) United States
(12) Patent Application Publication
(10) Pub. No.: US 2016/0238431 A1
(43) Pub. Date: Aug. 18, 2016

(54) LIQUID SURFACE SENSOR

(71) Applicant: DENSO CORPORATION, Kariya-city, Aichi-pref. (JP)

(72) Inventor: Naoto SUZUKI, Kariya-city (JP)

(21) Appl. No.: 15/027,040

(22) PCT Filed: Sep. 9, 2014
(86) PCT No.: PCT/JP2014/004620

§ 371 Date: Apr. 4, 2016

(30) Foreign Application Priority Data
Oct. 7, 2013 (JP) 2013-210334

(51) Int. Cl. G01F 23/62; H01H 35/18

(52) U.S. Cl. CPC G01F 23/62; H01H 35/18

(57) ABSTRACT

A liquid surface sensor includes a case fastened to a washer tank, and a float assembled to the case and is movable relative to the case in a vertical direction. The float supports a magnet. The case is provided with a reed switch axle receiving a reed switch that is switched to an off state to an on state when being approached by the magnet. The reed switch axle supports the float to move up and down. The reed switch includes a switch main body, and a conductive film covering an outer surface of the switch main body and extending from a reed is arranged on the switch main body. The conductive film transmits a signal that indicates an on state of a switch or an off state of the switch and is transmitted to the reed.

### CROSS REFERENCE TO RELATED APPLICATION

This application is based on Japanese Patent Application No. 2013-210334 filed on Oct. 7, 2013, the disclosure of which is incorporated herein by reference.

### TECHNICAL FIELD

The present disclosure relates to a liquid surface sensor applied to a container storing a liquid.

### BACKGROUND ART

Conventionally, Patent Literature 1 discloses a type of a liquid surface sensor having a configuration including a sensor main body fastened to a tank and a float provided to float on a liquid. In the configuration, since an insertion part arranged at the sensor main body is inserted into an insertion hole formed in the float, the float is assembled to the sensor main body and is movable in a vertical direction.

Further, the float supports a sensor magnet, and a reed switch is received in the insertion part arranged at the sensor main body. As the above configuration, when the sensor magnet approaches the reed switch according to a variation of a height of a liquid surface, the reed switch is switched from an off state to an on state.

According to the above configuration, the float is movable relative to the sensor main body in the vertical direction by a distance where the insertion part is movable in the insertion hole in the vertical direction. Therefore, when a height of the insertion part in the vertical direction becomes larger, a stroke amount that is the distance where the float is movable in the vertical direction becomes smaller. However, in the above configuration, in addition of the reed switch, a reed wiring that is a rod shape and transmits a signal from the reed switch is received in the insertion part. Therefore, the insertion part becomes large in size, and it is difficult to ensure a distance between the sensor magnet and the reed switch.

Then, the liquid surface sensor has to be used in an environment where a magnetic noise from external is applied to the liquid surface sensor. Further, it is possible that a direction of the magnetic noise applied from external matches a direction of a magnetic field generated by the sensor magnet. In this case, the magnetic field of the sensor magnet is increased by the magnetic noise. Thus, in the liquid surface sensor where the distance between the sensor magnet and the reed switch is insufficiently ensured, even though the sensor magnet is separated from the reed switch by a maximum distance, it is impossible that the reed switch is switched from the on state to the off state.

### PRIOR ART LITERATURES

### Patent Literature

Patent Literature 1: JP2010-107370A

### SUMMARY OF INVENTION

The present disclosure is made in view of the above matters, and it is an object of the present disclosure to provide a liquid surface sensor which improves a resistance for a magnetic noise applied from external.

According to an aspect of the present disclosure, to achieve the above object, the liquid surface sensor includes a fastened body including a fastened main body that is fastened to a container storing a liquid and an axle part that is a tubular shape and protrudes from the fastened main body, a float floating on the liquid and including an insertion hole into which the axle is inserted and assembled to the fastened body and being movable relative to the fastened body in a vertical direction in a case where the axle part is inserted into the through hole, a magnet part supported by the float and generating a magnetic field, and a switch mechanism received in the axle part. The switch mechanism includes a switch that is switched from an off state to an on state when being approached by the magnet part, a receiving part that receives the switch, an output part that is exposed from the receiving part toward a first direction of the axle part and to which a signal indicating the on state of the switch or the off state of the switch is transmitted, and a conductive film that is a film covering an outer surface of the receiving part and extending from the output part in a second direction opposite to the first direction and to which the signal transmitted to the output part is transmitted.

According to the present disclosure, the signal of the switch transmitted to the output part exposed from the receiving part toward the first direction can be transmitted through the conductive film extending from the output part in the second direction. As the above configuration, a reed wiring transmitting the signal from the output part may be not received in the axle part. Since the conductive film is a film covering the outer surface of the receiving part, a miniaturization of the axle part receiving the switch mechanism can be obtained.

In the axle part that is miniaturized, a height of the axle part in the vertical direction is suppressed. Therefore, a distance where the axle part can move in the vertical direction in the through hole is a stroke amount where the float can move relative to the fastened body in the vertical direction, and is enlarged. As the above description, a distance between the magnet part and the switch mechanism can be ensured. Thus, even though the direction of the magnetic field generated by the magnet part matches the direction of the magnetic field of the magnetic noise, the switch mechanism can be switched from the on state to the off state since the magnet part is separated from the switch mechanism. Thus, the liquid surface sensor in which a resistance for the magnetic noise applied from external is improved can be provided.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram showing a liquid surface sensor installed to a washer tank, according to a first embodiment of the present disclosure;

FIG. 2 is a plan view showing a reed switch connected with a terminal from a top side;

FIG. 3 is a perspective view showing the reed switch connected with the terminal;

FIG. 4 is a cross-sectional view along an IV-IV line in FIG. 1 and showing a shape of a cross-sectional surface of a reed switch axle;

FIG. 5 is a diagram showing a principle that a maximum distance between the reed switch and a magnet is enlarged according to a miniaturization of the reed switch axle;

FIG. 6 is a diagram showing the liquid surface sensor installed to the washer tank, according to a second embodiment of the present disclosure;

FIG. 7 is a plan view showing the reed switch connected with the terminal from the top side;

FIG. 8 is a perspective view showing the reed switch connected with the terminal; and

FIG. 9 is a cross-sectional view along an IX-IX line in FIG. 6 and showing the shape of the cross-sectional surface of the reed switch axle.

### DESCRIPTION OF EMBODIMENTS

Hereafter, referring to drawings, embodiments of the present disclosure will be described. The substantially same parts or components as those in the embodiments are indicated with the same reference numerals and the same descriptions may be omitted. When only a part of a configuration in each embodiment is detailed, the other parts of the configuration can be configured as the same as a prior embodiment. Further, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

### First Embodiment

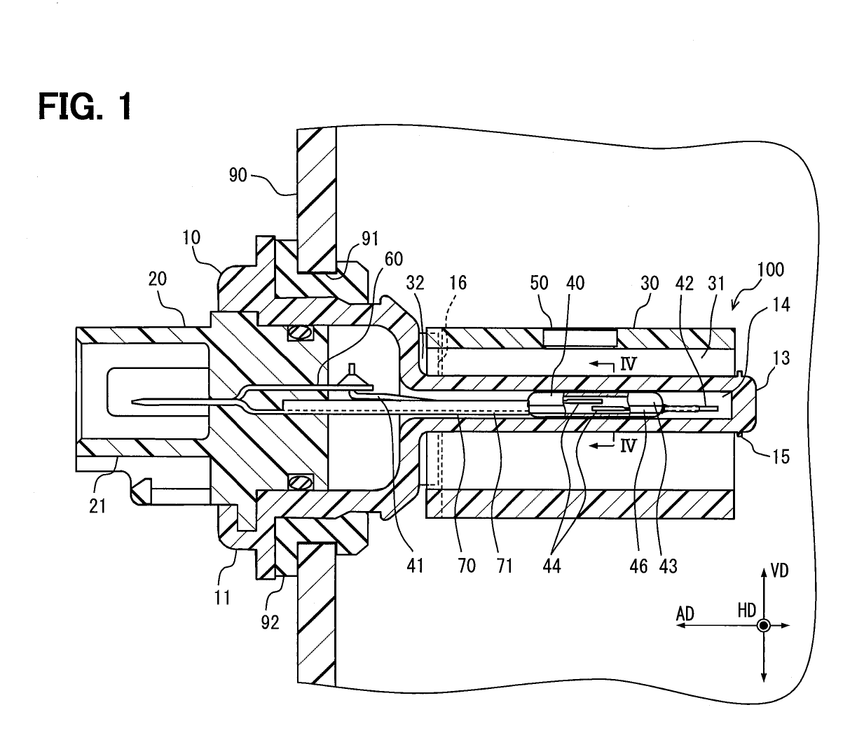

As shown in FIG. 1, a liquid surface sensor 100 according to a first embodiment of the present disclosure is installed to a washer tank 90. The washer tank 90 is mounted to an engine room of a vehicle, and stores a washer liquid as a liquid. The liquid surface sensor 100 detects a decrease of a liquid surface in accordance with a decrease in water liquid stored in the washer tank 90. The liquid surface sensor 100 is inserted into the washer tank 90 through an opening 91 formed on the washer tank 90.

First, a configuration of the liquid surface sensor 100 will be described. Further, hereafter, a direction in which the liquid surface sensor 100 is inserted into the opening 91 is referred to as an axial direction AD. Furthermore, a direction parallel to a direction of gravity is referred to as a vertical direction VD. Moreover, a direction substantially perpendicular to the axial direction AD and the vertical direction VD is referred to as a horizontal direction HD. In addition, the axial direction AD includes a first direction in which a reed switch axle 13 protrudes, and a second direction that is opposite to the first direction.

The liquid surface sensor 100 includes a case 10, a connector member 20, a float 30, a magnet 50, a reed switch 40, and terminals 60 and 70.

The case 10 is made of a resin material such as a polypropylene. The case 10 includes a fastened main body 11, the reed switch axle 13, and a limiting part 16. The fastened main body 11 is fastened to the washer tank 90 through a grommet 92. The fastened main body 11 is a ring shape and has a diameter larger than the opening 91 has. The fastened main body 11 and the grommet 92 cooperates to liquid-tightly seal the opening 91 from an exterior of the washer tank 90. The reed switch axle 13 is a tubular shape such as a cylindrical shape and protrudes in the first direction from a center of the fastened main body 11 along the axial direction AD. The reed switch axle 13 forms a receiving chamber 14 receiving the reed switch 40, according to a shape of the reed switch axle 13 protruding in the axial direction AD. The reed switch axle 13 includes a distal end in the first direction, and a flange part 15 is arranged at the distal end. The limiting part 16 is a wall part extending in the vertical direction VD. The limiting part 16 limits a rotation of the float 30 relative to the reed switch axle 13 by being in contact with the float 30.

The connector member 20 is made of a resin material such as a polyethylene-terephthalate. The connector member 20 is fitted into the fastened main body 11. The terminals 60 and 70 are fitted into the connector member 20. The connector member 20 includes an engagement part 21. When the engagement part 21 is engaged with a plug from external, the terminals 60 and 70 protruding in the engagement part 21 are electrically connected with a control circuit (not shown) from external.

The float 30 is made of a material having a specific gravity smaller than that of the washer liquid, and the float 30 can float on a liquid surface of the washer liquid. Specifically, the float 30 is made of a polypropylene resin added by a foaming agent. The float 30 is a columnar shape and extends in the axial direction AD. The float 30 includes a through hole 31 and a protrusion wall part 32. The through hole 31 is a through hole into which the reed switch axle 13 is inserted. The through hole 31 penetrates the float 30 in the axial direction AD. The through hole 31 has an inner width in the horizontal direction HD which is smaller than an outer width of the flange part 15 in the horizontal direction HD. When the reed switch axle 13 is inserted through the through hole 31, the float 30 is prevented from separating from the reed switch axle 13 according to the flange part 15. As the above configuration, the float 30 is assembled to the case 10, and is movable relative to the case 10 in the vertical direction VD. The protrusion wall part 32 is arranged at an end of the float 30 in the axial direction AD which is close to the fastened main body 11. The protrusion wall part 32 extends in the vertical direction VD. When the float 30 starts to rotate relative to the reed switch axle 13, the protrusion wall part 32 is in contact with the limiting part 16 to maintain a position of the float 30.

The magnet 50 is a permanent magnet such as a ferrite magnet, and generates a magnetic field. The magnet 50 is a rectangle in a cross section, and is a prismatic shape extending in the axial direction AD. The magnet 50 is supported by the float 30, and is placed at a position above the reed switch axle 13. The magnet 50 and the float 30 can move up and down by following the liquid surface.

The reed switch 40 is a switch mechanism detecting a height of the liquid surface. In this case, the height of the liquid surface is also a level of the liquid surface. The reed switch 40 includes a switch main body 43 which is a tubular shape such as a cylindrical shape and extends in the axial direction AD, and a pair of reeds 41 and 42 which penetrates the switch main body 43. The reed switch 40 is placed at a position where an axial direction of the switch main body 43 is parallel to the axial direction AD of the reed switch axle 13, and is received in the receiving chamber 14. The switch main body 43 is a glass pipe which is hollow and receives the reeds 41 and 42 which are a rod shape extending in the axial direction AD. According to the present embodiment, end parts of the reeds 41 and 42 are switch end parts. Each of the switch end parts can be bent. The switch end parts are arranged to be opposite to each other by a predetermined interval, so as to constitute a switch 44. Between the reeds 41 and 42, the reed 42 extends from the switch main body 43 in the first direction of the reed switch axle 13, and the reed 41 extends from the switch main body 43 in the second direction of the reed switch axle 13.

When a magnet field is applied to the reeds 41 and 42 from external, the switch end parts attract each other by being magnetized into different magnetic poles. Then, since the switch end parts are in contact with each other, the reed switch 40 is turned on to be conductive between the reeds 41 and 42. In this case, the reed switch 40 is in an on state. A signal indicating an on state or an off state of the switch 44 is transmitted to end parts of the reeds 41 and 42 exposed from the switch main body 43. According to the present embodiment, the end parts of the reeds 41 and 42 exposed from the switch main body 43 are output end parts.

The terminals 60 and 70 transmit a signal indicating the on state or an off state of the reed switch 40. The terminals 60 and 70 are a strip plate shape and extend in the axial direction AD. The terminals 60 and 70 have end parts protruding in the axial direction AD from the connector member 20. The terminal 60 is placed at a position above the terminal 70. In the fastened main body 11, the terminal 60 is connected to the reed 41 extending toward the connector member 20 from the switch main body 43 by soldering.

In the liquid surface sensor 100, when the liquid surface of the washer liquid is sufficiently high, the float 30 displaces upward in a direction perpendicular to the reed switch axle 13. In this case, since the magnet 50 is separated from the reed switch 40, the reed switch 40 is turned off. In this case, the reed switch 40 is in the off state. When the washer liquid stored in the washer tank 90 is decreased, the float 30 displaces downward in a direction perpendicular to the reed switch axle 13. Then, since the magnet 50 approaches the reed switch 40, the reed switch 40 is switched from the off state to the on state by the magnetic field generated by the magnet 50.

In the engine room where the liquid surface sensor 100 is arranged, magnets which are assembled to a motor and a power generator exist. Magnetic forces generated by the magnets are applied to the liquid surface sensor 100 as a magnetic noise applied from external. When a direction of the magnetic field generated by the magnet 50 matches a direction of the magnetic field of the magnetic noise, the magnetic field generated by the magnet 50 is increased. Then, even though the magnet 50 is separated from the reed switch 40 by a maximum distance, it is possible that the reed switch 40 is still in the on state. A configuration of the liquid surface sensor 100 which avoids a generation of the above matters will be described.

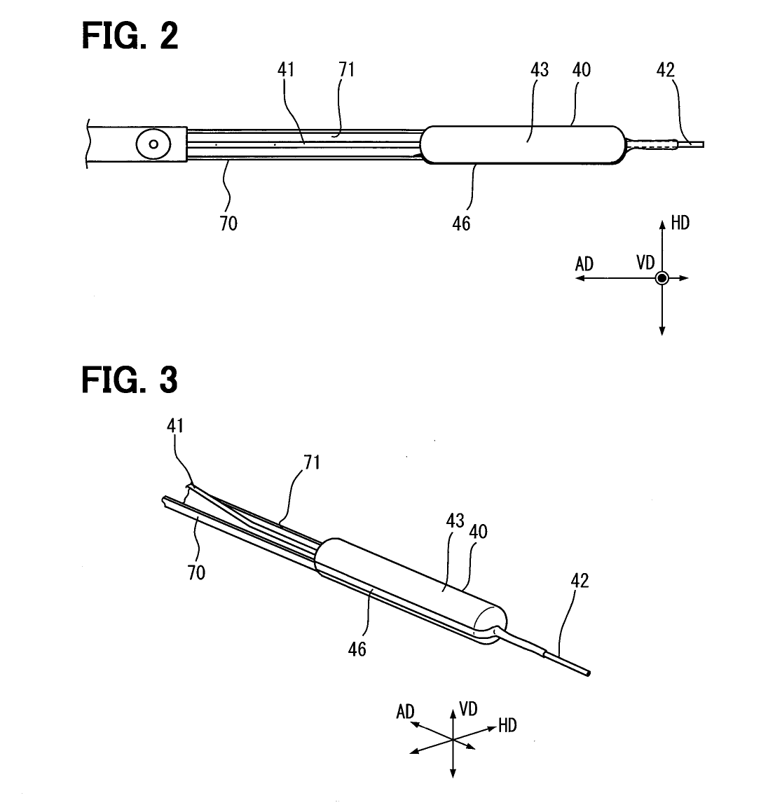

As shown in FIGS. 1 to 3, a conductive film 46 is arranged on the reed switch 40. The conductive film 46 is a thin film made by a conductive coating that is directly sprayed on an outer surface of the reed switch 40. Specifically, the conductive coating may be a silver coating, a silver-plated copper coating, a silver-plated nickel coating, a copper coating, or a nickel coating. The conductive film 46 covers the output end part of the reed 42 and extends in the second direction through an outer surface of the switch main body 43. The conductive film 46 is a strip shape, extends in the axial direction AD from the reed 42 to the terminal 70, and is connected with the terminal 70 in the reed switch axle 13. The conductive film 46 has a high conductivity and can transmit the signal of the switch 44 transmitted to the reed 42 to the terminal 70. The conductive film 46 is placed at a position that is separated from the reed 41 so as to prevent an occurrence of a short circuit between the conductive film 46 and the reed 41. The conductive film 46 is placed at a position of the outer surface of the switch main body 43 other than an area that covers the switch 44 in the vertical direction VD. According to the first embodiment, specifically, the conductive film 46 is placed at a position of the switch main body 43 that covers the switch 44 in the horizontal direction HD.

The terminal 70 includes a bent part 71. The bent part 71 is a part of the terminal 70 where the strip plate shape is bent into a semi-cylindrical shape. When a cross section of the terminal 70 is a section intersecting with the axial direction AD, a cross section of the bent part 71 that is parallel to the cross section of the terminal 70 is an arc shape and extends in a circumferential direction of the reed 41. As the above configuration, a part of the bent part 71, which is placed at a position in the receiving chamber 14, is separated from the reed 41 to generate a gap and surrounds an area underneath the reed 41.

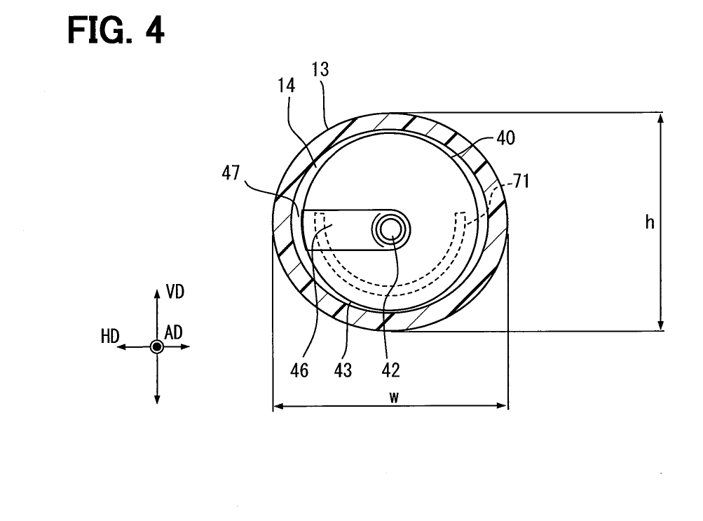

As shown in FIG. 4, a radius of curvature is substantially constant in the cross section of the bent part 71. Further, an outer diameter of the bent part 71 is set to be smaller than an outer diameter of the switch main body 43. Therefore, the bent part 71 is received in an area of the switch main body 43 which is projected in the second direction along the axial direction AD. Thus, the bent part 71 can be received in the receiving chamber 14 by fitting the switch main body 43.

As shown in FIG. 1, an end of the bent part 71 in the axial direction AD which is separated from the switch main body 43 is fitted into the connector member 20. Therefore, a step generated between the bent part 71 and a part of the terminal 70 which is a flat plate shape is not exposed to an exterior of the connector member 20. As the above configuration, when the terminal 70 is formed at the connector member 20 by an insert molding, it can be avoided that a situation where a mold release of a molding product is difficult or impossible due to the step of the terminal 70 in a step releasing the molding product from a molding die in the axial direction AD.

As shown in FIG. 4, the receiving chamber 14 formed in the reed switch axle 13 is an elliptical shape having a major axis that is in the horizontal direction HD. An inner dimension of the receiving chamber 14 in the vertical direction VD is slightly larger than the outer diameter of the switch main body 43. An inner dimension of the receiving chamber 14 in the horizontal direction HD is larger than the inner dimension of the receiving chamber 14 in the vertical direction VD. Therefore, a gap 47 through which the conductive film 46 passes in the horizontal direction HD is generated between an inner wall surface of the receiving chamber 14 and the outer surface of the switch main body 43. A shape of the reed switch axle 13 corresponds to a shape of the receiving chamber 14 in the cross section. Specifically, a height h of the reed switch axle 13 in the vertical direction VD is slightly larger than a width w of the reed switch axle 13 in the horizontal direction HD.

As the above configuration, a transmission member that is arranged to span the switch main body 43 in the axial direction AD and transmits the signal from the reed 42 may be not received in the receiving chamber 14. In addition, since the conductive film 46 is a film covering the outer surface of the switch main body 43, a miniaturization of the reed switch axle 13 forming the receiving chamber 14 can be obtained.

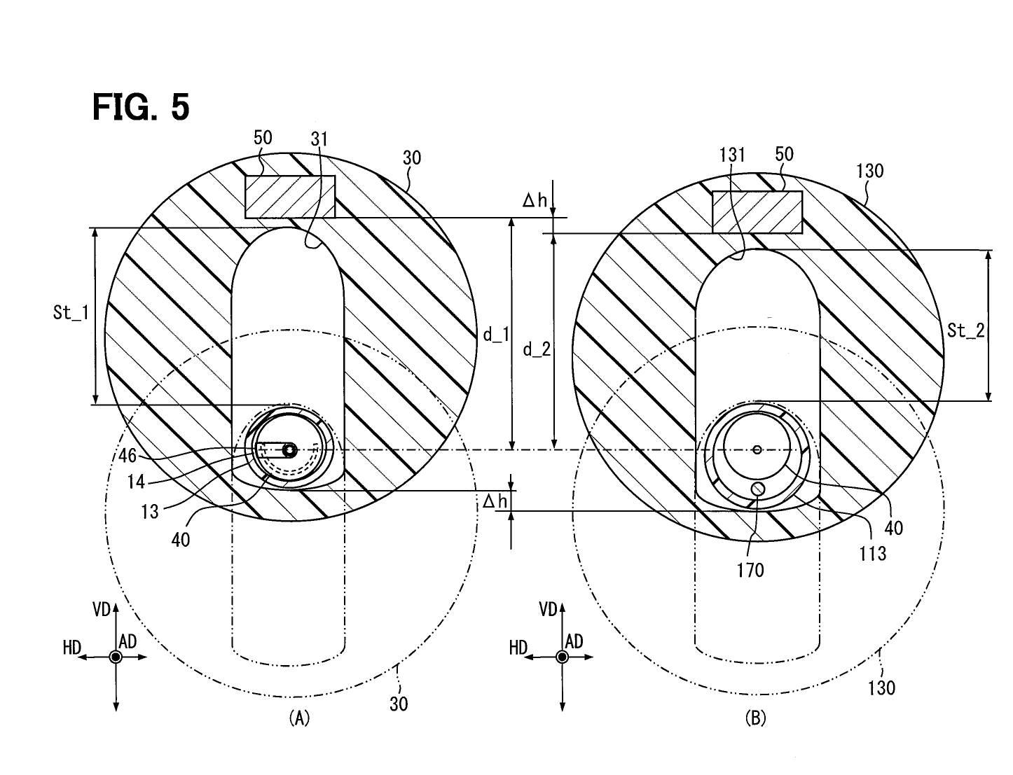

When the magnet 50 is separated from the reed switch 40 by the maximum distance, a maximum separating distance d_1 that is a distance between the magnet 50 and the reed switch 40 is enlarged according to the miniaturization of the reed switch axle 13. Referring to FIGS. 5(A) and 5(B), a principle of the above phenomenon will be described. FIG. 5(B) is a diagram showing an operation of a float 130 in a case where a terminal 170 that is a rod shape and spans a switch main body, for a comparison. Further, the float 130 includes a through hole 131 having an inner dimension in the vertical direction VD that is equal to an inner dimension of the through hole 31 of the float 30.

A stroke amount St_1 of the float 30 and a stroke amount St_2 of the float 130 are determined according to the inner dimensions of the through holes 31, 131 in the vertical direction VD and heights h (refer to FIG. 4) of reed switch axles 13, 113 in the vertical direction VD, respectively. In this case, since the conductive film 46 is provided, the height h of the reed switch axle 13 is decreased by Δh from the height h of the reed switch axle 113 of an example where the terminal 70 is arranged in the receiving chamber 14. Therefore, the stroke amount St_1 becomes larger than the stroke amount St_2 by a distance that is substantially equal to Δh that is a decreasing amount of the height h. Thus, the maximum separating distance d_1 between the reed switch 40 and the magnet 50 in an example where the conductive film 46 is used to decrease the height h is larger than the maximum separating distance d_2 between the reed switch 40 and the magnet 50 in an example where the terminal 170 is provided by Δh.

According to the first embodiment, the height h of the reed switch axle 13 is suppressed according to the miniaturization of the reed switch axle 13. Therefore, a distance where the reed switch axle 13 can move in the vertical direction VD in the through hole 31 is the stroke amount St_1 where the float 30 can move relative to the case 10 in the vertical direction VD, and the stroke amount St_1 is enlarged. As the above description, the maximum separating distance d_1 between the magnet 50 and the reed switch 40 can be ensured. Therefore, even though the direction of the magnetic field generated by the magnet 50 matches the direction of the magnetic field of the magnetic noise, the reed switch 40 can be switched from the on state to the off state since the magnet 50 is separated from the reed switch 40. Thus, the liquid surface sensor 100 in which a resistance for the magnetic noise applied from external is improved can be provided.

According to the first embodiment, since the terminal 70 is connected with the conductive film 46, the terminal 70 functions to transmit signals. As the above configuration, a forming area of the conductive film 46 is limited to the outer surface of the switch main body 43 and an outer surface of the reed 42 protruding from the switch main body 43. Then, since the forming area of the conductive film 46 is narrowed, it is difficult that the conductive film 46 is damaged.

According to the first embodiment, since an area of the cross section of the bent part 71 is smaller than an area of a cross section of the switch main body 43, the bent part 71 can be received in a space in the receiving chamber 14 through which the switch main body 43 passes. As the above description, it can be avoided that the reed switch axle 13 is increased in size to receive the terminal 70.

According to the first embodiment, in the receiving chamber 14 that is narrowed due to the conductive film 46, a gap can be generated between the terminal 70 where the bent part 71 that is a semi-cylindrical shape is provided, and the reed 41. Therefore, it can be avoided that the terminal 70 and the reed 41 are in contact with each other in the receiving chamber 14 so as to lead to a short circuit. As the above description, it is preferable that a configuration that the bent part 71 is provided in the terminal 70 is applied to an example where the switch main body 43 is miniaturized by the conductive film 46.

According to the first embodiment, the gap 47 through which the conductive film 46 passes is ensured between the inner wall surface of the receiving chamber 14 and the outer surface of the switch main body 43. Therefore, even though a vibration is transmitted to the liquid surface sensor 100 from external, it can be avoided that the conductive film 46 is damaged due to a friction between the conductive film 46 and the inner wall surface.

According to the first embodiment, the conductive film 46 is placed at a position of a side surface of the switch main body 43 other than an area that covers the switch 44 in the vertical direction VD. Therefore, it is impossible that an increasing in size of the reed switch axle 13 in the vertical direction VD is generated due to the gap 47. Thus, a high reliability of the conductive film 46 can be ensured, and the resistance for the magnetic noise is improved.

According to the first embodiment, the case 10 is equivalent to a fastened body, the reed switch axle 13 is equivalent to an axle part, and the connector member 20 is equivalent to a support member. Further, the through hole 31 is equivalent to an insertion hole, the reed switch 40 is equivalent to a switch mechanism, the reed 41 is equivalent to a reed part, and the reed 42 is equivalent to an output part. Furthermore, the switch main body 43 is equivalent to a receiving part, the magnet 50 is equivalent to a magnet part, and the terminal 70 is equivalent to a connection member. Moreover, the washer tank 90 is equivalent to a container.

### Second Embodiment

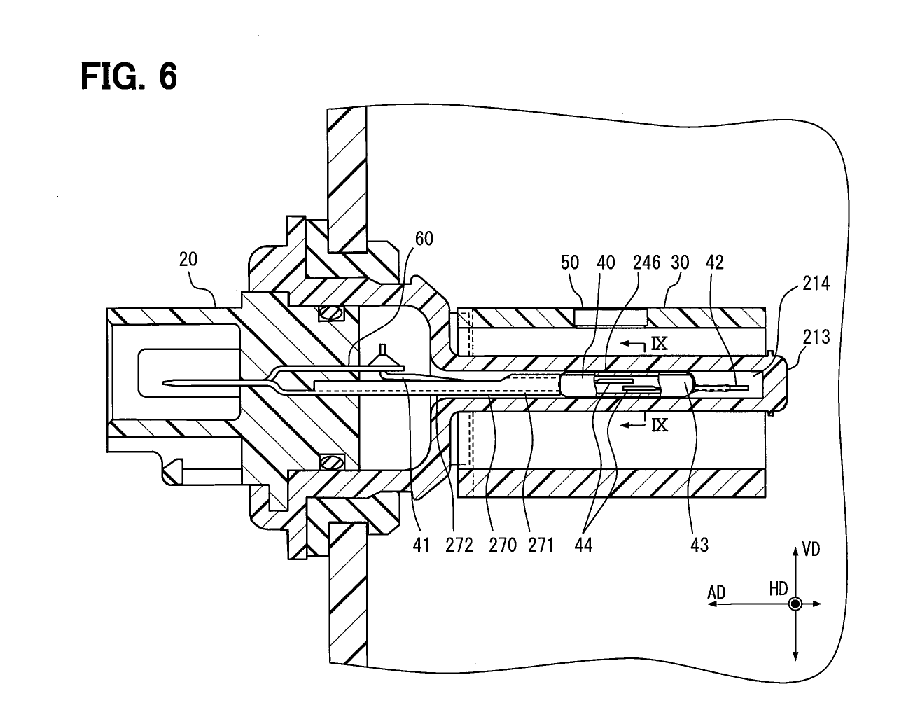

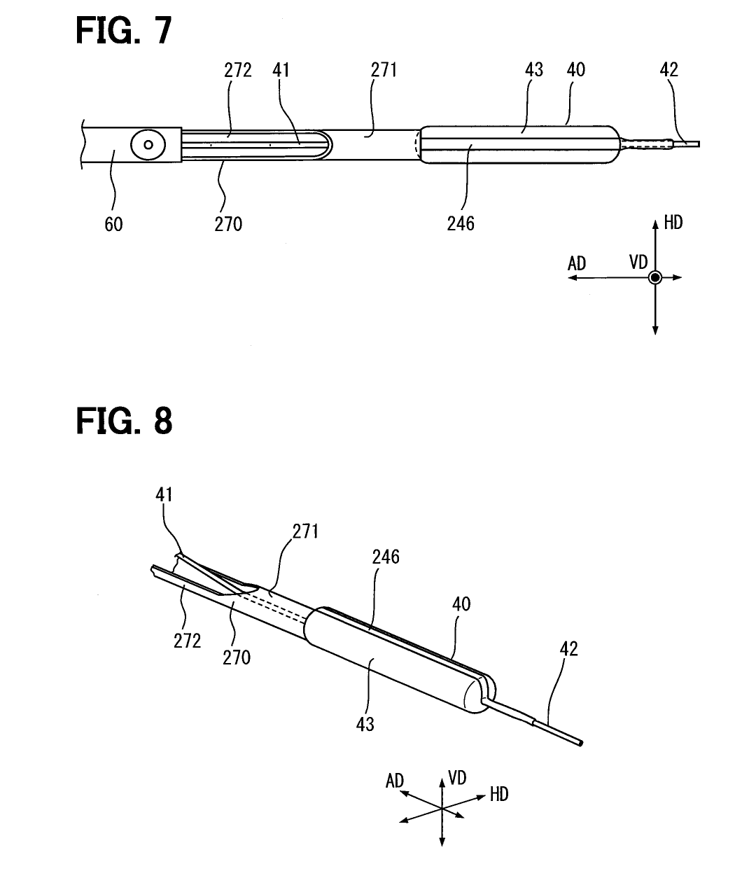

A second embodiment of the present disclosure shown in FIGS. 6 to 9 is a modification example of the first embodiment. As shown in FIGS. 6 to 8, in the second embodiment, a conductive film 246 arranged on the reed switch 40 is a strip shape and extends in the axial direction AD from the reed 42 to a terminal 270. The conductive film 246 is placed at a position of the outer surface of the switch main body 43 over the switch 44.

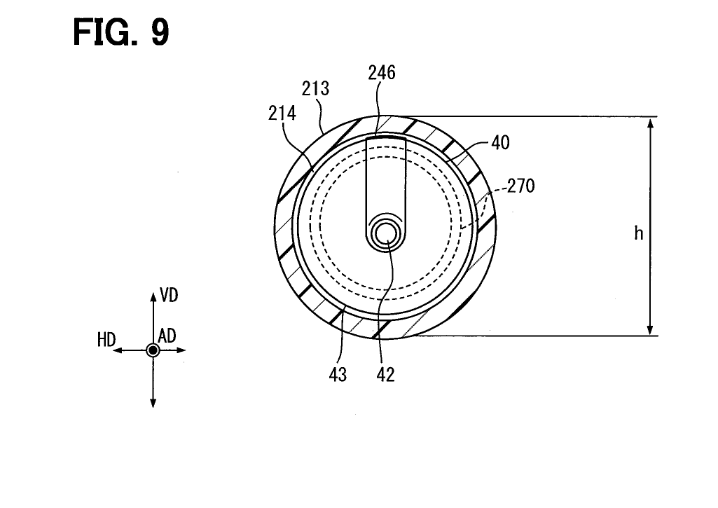

The terminal 270 includes a cylindrical part 271 and a semi-cylindrical part 272. As shown in FIG. 9, an outer diameter of the cylindrical part 271 and an outer diameter of the semi-cylindrical part 272 are smaller than the outer diameter of the switch main body 43. Therefore, the cylindrical part 271 and the semi-cylindrical part 272 are received in a receiving chamber 214. The cylindrical part 271 is in contact with the switch main body 43 and is electrically connected with the conductive film 246. The cylindrical part 271 is separated from the reed 41 to generate a gap and surrounds an entire periphery of the reed 41. The semi-cylindrical part 272 is interposed between the cylindrical part 271 and the connector member 20. The semi-cylindrical part 272 is separated from the reed 41 to generate a gap and is a semi-cylindrical shape surrounding an area underneath the reed 41. The semi-cylindrical part 272 is open at an area over the reed 41. Thus, the semi-cylindrical part 272 can be connected with the terminal 60 placed at a position over the terminal 270, and can be connected with the reed 41.

According to the second embodiment, as shown in FIGS. 6 and 9, a reed switch axle 213 is a tubular shape such as a cylindrical shape. Since the conductive film 246 is provided, a transmission member transmitting the signal from the reed 42 is cancelled from the receiving chamber 214. An inner diameter of the reed switch axle 213 is slightly larger than the outer diameter of the switch main body 43. Thus, the miniaturization of the reed switch axle 213 that forms the receiving chamber 214 is achieved.

According to the second embodiment, a height h of the reed switch axle 213 is suppressed according to the miniaturization of the reed switch axle 213, as the same as the height h of the reed switch axle 213 in the first embodiment. Therefore, as shown in FIG. 6, a stroke amount where the float 30 can move in the vertical direction VD is enlarged. Thus, the resistance for the magnetic noise applied from external is improved.

According to the second embodiment, the reed switch axle 213 is equivalent to the axle part, the terminal 270 is equivalent to the connection member, and the cylindrical part 271 and the semi-cylindrical part 272 are equivalent to the bent part.

### Other Embodiment

The present disclosure is not limited to the embodiments mentioned above, and can be applied to various embodiments and combinations within the spirit and scope of the present disclosure.

According to the above embodiments, since the resistance for the magnetic noise in the liquid surface sensor is ensured, a type number of the liquid surface sensor can be decreased. Specifically, in a conventional liquid surface sensor, since a resistance for a magnetic noise is insufficient, it is necessary to control a direction of a magnetic force generated by a magnet to be opposite to a direction of a magnetic noise. According to the above configuration, since the magnetic force of the magnet and the magnetic noise cancel each other, it is difficult that an erroneous operation of a reed switch is generated due to the magnetic noise. However, in this case, it is necessary that an attachment direction of the magnet changes according to a type of a vehicle to which the liquid surface sensor is installed, and then a new type of the liquid surface sensor is generated. According to the above embodiments, in the liquid surface sensor, since the maximum separating distance between the reed switch and the magnet is enlarged, the resistance for the magnetic noise is ensured. Therefore, the same type of the liquid surface sensor can be used without respect to the type of the vehicle to which the liquid surface sensor is installed. Thus, since it is unnecessary to change a direction of the reed switch and a direction of the magnet according to the type of the vehicle, a cost of the liquid surface sensor is reduced by decreasing the type of the liquid surface sensor.

According to the above embodiments, a shape of the conductive film that is a strip shape and has a narrow width can be properly changed. For example, the conductive film may be a shape that a width of the conductive film is continuously enlarged toward a direction opposite to the first direction of the reed switch axle. Alternatively, plural conductive films may be arranged on the outer surface of the switch main body.

According to the above embodiments, the case is assembled to the opening of the washer tank as the fastened body. However, a configuration of the fastened body may be properly changed. For example, an assembly that is constituted by the case and a bracket may be equivalent to the fastened body. Further, when a shape of the cross section of the reed switch axle can suppress the height of the reed switch axle in the vertical direction VD, the shape may be different from the above mentioned shapes. Furthermore, a shape of the insertion hole may be properly changed to fit the shape of the reed switch axle.

According to the above embodiments, the terminals 70 and 270 are a shape that is bent to surround the reed 41. However, when the terminals 70 and 270 are separated from the reed 41 to generate a gap, the terminals 70 and 270 may be a member that is a flat strip plate shape or a rod shape, and the member may extend along the reed 41 as the connection member. Alternatively, since the connection member is larger than the switch main body in the horizontal direction HD, the connection member may be a shape protruding from the area of the switch main body which is projected in the axial direction AD. Further, a shape of the reeds 41 and 42 which are equivalent to the output part and the reed part is not limited to a rod shape, and may be properly changed.

According to the above embodiments, the magnet that is a rectangle plate shape is used as the magnet part. However, a shape and a material of a member that is equivalent to the magnet part may be properly changed. Further, a position of the magnet part which is supported may be properly changed. Furthermore, plural magnets may be used to constitute the magnet part. Moreover, the magnet part may be placed at a position underneath the reed switch. A configuration that is equivalent to the switch mechanism is not limited to the reed switch, and may be properly changed.

As the above description, the present disclosure is described based on examples in which the liquid surface sensor detects the height of the liquid surface of the washer liquid stored in the washer tank of the vehicle. However, the present disclosure is not limited to be applied to a detection of the height of the liquid surface of the washer liquid. The present disclosure can be applied to a liquid surface sensor in a container which is installed to a vehicle. In this case, the container may stores a liquid other than the above mentioned liquid, such as an engine oil, a brake fluid, an engine coolant, and a fuel. Further, the present disclosure can be applied to a liquid surface sensor used in a container including various consumer appliances or various transportation machines, without being limited to the vehicle.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A liquid surface sensor, comprising:
a fastened body including a fastened main body that is fastened to a container storing a liquid, and an axle part that is a tubular shape and protrudes from the fastened main body;
a float floating on the liquid, the float including an insertion hole into which the axle is inserted, the float assembled to the fastened body, the float being movable relative to the fastened body in a vertical direction in a case where the axle part is inserted into the through hole;
a magnet part supported by the float, the magnet part generating a magnetic field; and
a switch mechanism received in the axle part, the switch mechanism including a switch that is switched from an off state to an on state when being approached by the magnet part, a receiving part that receives the switch, an output part that is exposed from the receiving part toward a first direction of the axle part and to which a signal indicating the on state of the switch or the off state of the switch is transmitted, and a conductive film that is a film covering an outer surface of the receiving part and extending from the output part in a second direction opposite to the first direction and to which the signal transmitted to the output part is transmitted.

2. The liquid surface sensor according to claim 1, further comprising:
a support member supported by the fastened body; and
a connection member extending from the support member to the receiving part, the connection member connected with the conductive film in the axle part, the connection member having a conductivity.

3. The liquid surface sensor according to claim 2, wherein
the connection member includes a part that is received in the axle part, and the part is received in an area of the receiving part which is projected in the second direction along an axial direction of the axle part.

4. The liquid surface sensor according to claim 2, wherein
the switch mechanism further includes a reed part that is a rod shape and extends from the receiving part toward the second direction and to which the signal indicating the on state of the switch or the off state of the switch is transmitted, and
the connection member is separated from the reed part to generate a gap in the axle part, and the connection member includes a bent part surrounding the reed part.

5. The liquid surface sensor according to claim 1, wherein
the conductive film is placed at a position of the receiving part other than an area that covers the switch in the vertical direction, and
the axle part generates a gap, through which the conductive film passes in the horizontal direction, between the receiving part received in the axle part and the axle part.
